(19) United States
(12) Patent Application Publication
(10) Pub. No.: US 2004/0049603 A1
(43) Pub. Date: Mar. 11, 2004

(54) iSCSI driver to adapter interface protocol

(75) Inventors: William Todd Boyd, Poughkeepsie, NY (US); Douglas J. Joseph, Danbury, CT (US); Michael Anthony Ko, San Jose, CA (US); Renato John Recio, Austin, TX (US)

Correspondence Address: Duke W. Yee, Cartstens, Yee & Cahoon, LLP, P.O. Box 802334, Dallas, TX, 75380, US

(73) Assignee: International Business Machines Corporation, Armonk, NY

(21) Appl. No.: 10/235,686

(22) Filed: Sep. 5, 2002

(51) Int. Cl. G06F 3/00

(52) U.S. Cl. 710/1

(57) ABSTRACT

The present invention provides a method, computer program product, and distributed data processing system to allow the hardware mechanism of the Internet Protocol Suite Offload Engine (IPSOE) to interpret the iSCSI commands, process the iSCSI commands, and to interpret the iSCSI command completion results with the iSCSI driver. The distributed data processing system comprises endnodes, switches, routers, and links interconnecting the components. The endnodes use send and receive queue pairs to transmit and receive messages. The endnodes segment the message into frames and transmit the frames over the links. The switches and routers interconnect the endnodes and route the frames to the appropriate endnodes. The endnodes reassemble the frames into a message at the destination.

### CROSS REFERENCE TO RELATED APPLICATIONS

The present invention is related to an application entitled MEMORY MANAGEMENT OFFLOAD FOR RDMA ENABLED NETWORK ADAPTERS, Ser. No. ______, attorney docket no. AUS920020129US1, filed even date hereof, assigned to the same assignee, and incorporated herein by reference.

### BACKGROUND OF THE INVENTION

1. Technical Field

The present invention generally relates to communication protocols between a host computer and an input/output (I/O) device. More specifically, the present invention provides a method by which the Queue Pair resources used by a Remote Direct Memory Access over Transmission Control Protocol can be used to perform the iSCSI storage protocol.

2. Description of Related Art

In an Internet Protocol (IP) Network, the software provides a message passing mechanism that can be used to communicate with Input/Output devices, general purpose computers (host), and special purpose computers. The message passing mechanism consists of a transport protocol, an upper level protocol, and an application programming interface. The key standard transport protocols used on IP networks today are the Transmission Control Protocol (MCP) and the User Datagram Protocol (UDP). TCP provides a reliable service and UDP provides an unreliable service. In the future the Stream Control Transmission Protocol (SCTP) will also be used to provide a reliable service. Processes executing on devices or computers access the IP network through Upper Level Protocols, such as Sockets, iSCSI, and Direct Access File System (DAFS).

Unfortunately the TCP/IP software consumes a considerable amount of processor and memory resources. This problem has been covered extensively in the literature (see J. Kay, J. Pasquale, “Profiling and reducing processing overheads in TCP/IP”, IEEE/ACM Transactions on Networking, Vol 4, No. 6, pp.817-828, December 1996; and D. D. Clark, V. Jacobson, J. Romkey, H. Salwen, “An analysis of TCP processing overhead”, IEEE Communications Magazine, Vol. 27, Issue 6, June 1989, pp 23-29). In the future the network stack will continue to consume excessive resources for several reasons, including: increased use of networking by applications; use of network security protocols; and the underlying fabric bandwidths are increasing at a higher rate than microprocessor and memory bandwidths. To address this problem the industry is offloading the network stack processing to an IP Suite Offload Engine (IPSOE).

There are two offload approaches being taken in the industry. The first approach uses the existing TCP/IP network stack, without adding any additional protocols. This approach can offload TCP/IP to hardware, but unfortunately does not remove the need for receive side copies. As noted in the papers above, copies are one of the largest contributors to CPU utilization. To remove the need for copies, the industry is pursuing the second approach that consists of adding Framing, Direct Data Placement (DDP), and Remote Direct Memory Access (RDMA) over the TCP and SCTP protocols. The IP Suite Offload Engine (IPSOE) required to support these two approaches is similar, the key difference being that in the second approach the hardware must support the additional protocols.

The IPSOE provides a message passing mechanism that can be used by sockets, iSCSI, and DAFS to communicate between nodes. Processes executing on host computers, or devices, access the IP network by posting send/receive messages to send/receive work queues on an IPSOE. These processes also are referred to as “consumers”.

The send/receive work queues (WQ) are assigned to a consumer as a queue pair (QP). The messages can be sent over several different transport types: traditional TCP, RDMA TCP, UDP, or SCTP. Consumers retrieve the results of these messages from a completion queue (CQ) through IPSOE send and receive work completion (WC) queues. The source IPSOE takes care of segmenting outbound messages and sending them to the destination. The destination IPSOE takes care of reassembling inbound messages and placing them in the memory space designated by the destination's consumer. These consumers use IPSO verbs to access the functions supported by the IPSOE. The software that interprets verbs and directly accesses the IPSOE is known as the IPSO interface (IPSOI).

Today the host CPU performs most of IP suite processing. IP Suite Offload Engines provide higer performance for communicating to other general purpose computers and I/O devices. However, a simple mechanism is needed to allow the hardware mechanism in IPSOE to interpret the iSCSI commands, process the iSCSI commands, and to interpret the iSCSI command completion results.

### SUMMARY OF THE INVENTION

The present invention provides a method, computer program product, and distributed data processing system for the iSCSI driver to interface to the Internet Protocol Suite Offload Engine (IPSOE). The distributed data processing system comprises endnodes, switches, routers, and links interconnecting the components. The endnodes use send and receive queue pairs to transmit and receive messages. The endnodes segment the message into segments and transmit the segments over the links. The switches and routers interconnect the endnodes and route the segments to the appropriate endnodes. The endnodes reassemble the segments into a message at the destination.

The present invention provides a mechanism for IPSOE to interpret iSCSI commands, process the iSCSI commands, and interpret the iSCSI command completion results. Using the mechanism provided in the present invention allows IPSOE to offload the iSCSI functions from the host CPU, thus making more CPU resources available for running application software.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a diagram illustrating a distributed computer system in accordance with a preferred embodiment of the present invention;

FIG. 2 depicts a functional block diagram illustrating a host processor node in accordance with a preferred embodiment of the present invention;

FIG. 3A depicts a diagram illustrating a IPSOE in accordance with a preferred embodiment of the present invention;

FIG. 3B depicts a diagram illustrating a switch in accordance with a preferred embodiment of the present invention;

FIG. 3C depicts a diagram illustrating a router in accordance with a preferred embodiment of the present invention;

FIG. 4 depicts a diagram illustrating processing of work requests in accordance with a preferred embodiment of the present invention;

FIG. 5 depicts a diagram illustrating a portion of a distributed computer system in accordance with a preferred embodiment of the present invention in which a TCP or SCTP transport is used;

FIG. 6 depicts a diagram illustrating a data frame in accordance with a preferred embodiment of the present invention;

FIG. 7 depicts a diagram illustrating a portion of a distributed computer system in accordance with a preferred embodiment of the present invention;

FIG. 8 depicts a diagram illustrating the network addressing used in a distributed networking system in accordance with the present invention;

FIG. 9 depicts a diagram illustrating a portion of a distributed computer system in accordance with a preferred embodiment of the present invention;

FIG. 10 depicts a diagram illustrating a layered communication architecture used in a preferred embodiment of the present invention;

FIG. 11 depicts a schematic diagram illustrating the QP states in accordance with the present invention;

FIG. 12 depicts a schematic diagram of the iSQP Context in accordance with the present invention;

FIG. 13 depicts a schematic diagram of the WQ in accordance with the present invention;

FIG. 14 depicts a schematic diagram of the CQ and CQ Context in accordance with the present invention;

FIG. 15 is a flowchart representation of a process of a host initiating an iSCSI transaction with a target adapter in accordance with a preferred embodiment of the present invention; and

FIG. 16 is a flowchart representation of a process of fulfilling an iSCSI command by a target adapter in accordance with a preferred embodiment of the present invention.

### DETAILED DESCRIPTION OF THE PREFERRED EMBODIMENT

The present invention provides a distributed computing system having endnodes, switches, routers, and links interconnecting these components. The endnodes can be Internet Protocol Suite Offload Engines or traditional host software based internet protocol suites. Each endnode uses send and receive queue pairs to transmit and receive messages. The endnodes segment the message into frames and transmit the frames over the links. The switches and routers interconnect the endnodes and route the frames to the appropriate endnode. The endnodes reassemble the frames into a message at the destination.

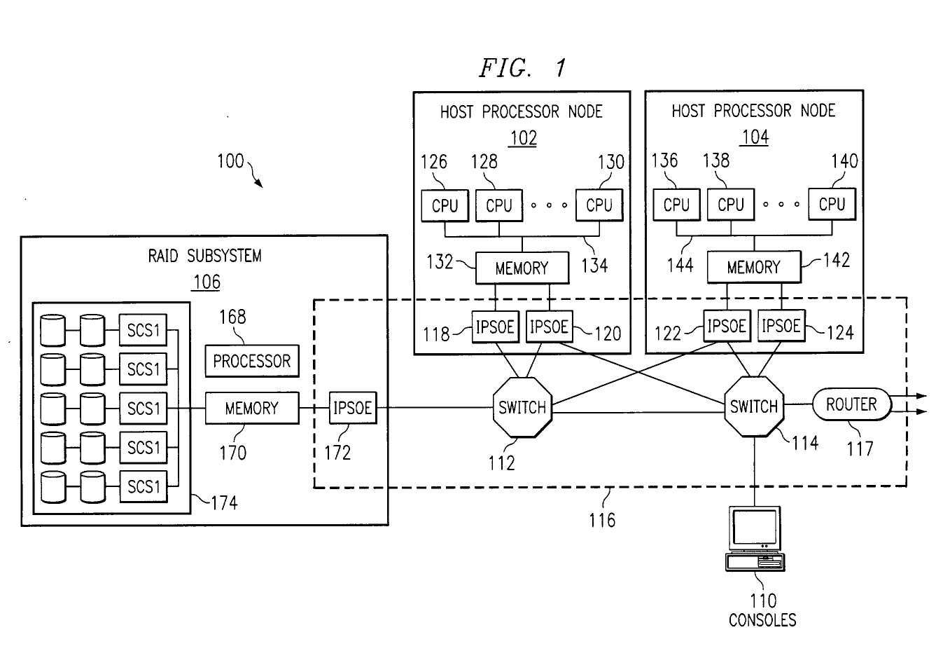

With reference now to the figures and in particular with reference to FIG. 1, a diagram of a distributed computer system is illustrated in accordance with a preferred embodiment of the present invention. The distributed computer system represented in FIG. 1 takes the form of an internet protocol network (IP net) 100 and is provided merely for illustrative purposes, and the embodiments of the present invention described below can be implemented on computer systems of numerous other types and configurations. For example, computer systems implementing the present invention can range from a small server with one processor and a few input/output (I/O) adapters to massively parallel supercomputer systems with hundreds or thousands of processors and thousands of I/O adapters. Furthermore, the present invention can be implemented in an infrastructure of remote computer systems connected by an internet or intranet.

IP net 100 is a high-bandwidth, low-latency network interconnecting nodes within the distributed computer system. A node is any component attached to one or more links of a network and forming the origin and/or destination of messages within the network. In the depicted example, IP net 100 includes nodes in the form of host processor node 102, host processor node 104, and redundant array independent disk (RAID) subsystem node 106. The nodes illustrated in FIG. 1 are for illustrative purposes only, as IP net 100 can connect any number and any type of independent processor nodes, storage nodes, and special purpose processing nodes. Any one of the nodes can function as an endnode, which is herein defined to be a device that originates or finally consumes messages or frames in IP net 100.

In one embodiment of the present invention, an error handling mechanism in distributed computer systems is present in which the error handling mechanism allows for TCP or SCTP communication between endnodes in a distributed computing system, such as IP net 100.

A message, as used herein, is an application-defined unit of data exchange, which is a primitive unit of communication between cooperating processes. A frame is one unit of data encapsulated by Internet Protocol Suite headers and/or trailers. The headers generally provide control and routing information for directing the frame through IP net 100. The trailer generally contains control and cyclic redundancy check (CRC) data for ensuring frames are not delivered with corrupted contents.

Within a distributed computer system, IP net 100 contains the communications and management infrastructure supporting various forms of traffic, such as storage, interprocess communications (IPC), file access, and sockets. The IP net 100 shown in FIG. 1 includes a switched communications fabric 116, which allows many devices to concurrently transfer data with high-bandwidth and low latency in a secure, remotely managed environment. Endnodes can communicate over multiple ports and utilize multiple paths through the IP net fabric. The multiple ports and paths through the IP net fabric shown in FIG. 1 can be employed for fault tolerance and increased bandwidth data transfers.

The IP net 100 in FIG. 1 includes switch 112, switch 114, and router 117. A switch is a device that connects multiple links together and allows routing of frames from one link to another link using the layer 2 destination address field. When the Ethernet is used as the link, the destination field is known as the Media Access Control (MAC) address. A router is a device that routes frames based on the layer 3 destination address field. When Internet Protocol (IP) is used as the layer 3 protocol, the destination address field is an IP address.

In one embodiment, a link is a full duplex channel between any two network fabric elements, such as endnodes, switches, or routers. Example suitable links include, but are not limited to, copper cables, optical cables, and printed circuit copper traces on backplanes and printed circuit boards.

For reliable service types (TCP and SCTP), endnodes, such as host processor endnodes and I/O adapter endnodes, generate request frames and return acknowledgment frames. Switches and routers pass frames along, from the source to the destination.

In IP net 100 as illustrated in FIG. 1, host processor node 102, host processor node 104, and RAID subsystem 106 include at least IPSOE to interface to IP net 100. In one embodiment, each IPSOE is an endpoint that implements the IPSOI in sufficient detail to source or sink frames transmitted on IP net fabric 100. Host processor node 102 contains IPSOEs in the form of host IPSOE 118 and IPSOE 120. Host processor node 104 contains IPSOE 122 and IPSOE 124. Host processor node 102 also includes central processing units 126-130 and a memory 132 interconnected by bus system 134. Host processor node 104 similarly includes central processing units 136-140 and a memory 142 interconnected by a bus system 144.

IP Suite Offload Engine 118 provides a connection to switch 112, while IP Suite Offload Engine 124 provides a connection to switch 114, and IP Suite Offload Engines 120 and 122 provide a connection to switches 112 and 114.

In one embodiment, an IP Suite Offload Engine is implemented in hardware or a combination of hardware and offload microprocessor(s). In this implementation, IP suite processing is offloaded to the IPSOE. This implementation also permits multiple concurrent communications over a switched network without the traditional overhead associated with communicating protocols. In one embodiment, the IPSOEs and IP net 100 in FIG. 1 provide the consumers of the distributed computer system with zero processor-copy data transfers without involving the operating system kernel process, and employs hardware to provide reliable, fault tolerant communications.

As indicated in FIG. 1, router 117 is coupled to wide area network (WAN) and/or local area network (LAN) connections to other hosts or other routers.

In this example, RAID subsystem node 106 in FIG. 1 includes a processor 168, a memory 170, an IP Suite Offload Engine (IPSOE) 172, and multiple redundant and/or striped storage disk unit 174.

IP net 100 handles data communications for storage, interprocessor communications, file accesses, and sockets. IP net 100 supports high-bandwidth, scalable, and extremely low latency communications. User clients can bypass the operating system kernel process and directly access network communication components, such as IPSOEs, which enable efficient message passing protocols. IP net 100 is suited to current computing models and is a building block for new forms of storage, cluster, and general networking communication. Further, IP net 100 in FIG. 1 allows storage nodes to communicate among themselves or communicate with any or all of the processor nodes in a distributed computer system. With storage attached to IP net 100, the storage node has substantially the same communication capability as any host processor node in IP net 100.

In one embodiment, IP net 100 shown in FIG. 1 supports channel semantics and memory semantics. Channel semantics is sometimes referred to as send/receive or push communication operations. Channel semantics are the type of communications employed in a traditional I/O channel where a source device pushes data and a destination device determines a final destination of the data. In channel semantics, the frame transmitted from a source process specifies a destination processes' communication port, but does not specify where in the destination processes' memory space the frame will be written. Thus, in channel semantics, the destination process pre-allocates where to place the transmitted data.

In memory semantics, a source process directly reads or writes the virtual address space of a remote node destination process. The remote destination process need only communicate the location of a buffer for data, and does not need to be involved in the transfer of any data. Thus, in memory semantics, a source process sends a data frame containing the destination buffer memory address of the destination process. In memory semantics, the destination process previously grants permission for the source process to access its memory.

Channel semantics and memory semantics are typically both necessary for storage, cluster, and general networking communications. A typical storage operation employs a combination of channel and memory semantics. In an illustrative example storage operation of the distributed computer system shown in FIG. 1, a host processor node, such as host processor node 102, initiates a storage operation by using channel semantics to send a disk write command to the RAID subsystem IPSOE 172. The RAID subsystem examines the command and uses memory semantics to read the data buffer directly from the memory space of the host processor node. After the data buffer is read, the RAID subsystem employs channel semantics to push an I/O completion message back to the host processor node.

In one exemplary embodiment, the distributed computer system shown in FIG. 1 performs operations that employ virtual addresses and virtual memory protection mechanisms to ensure correct and proper access to all memory. Applications running in such a distributed computer system are not required to use physical addressing for any operations.

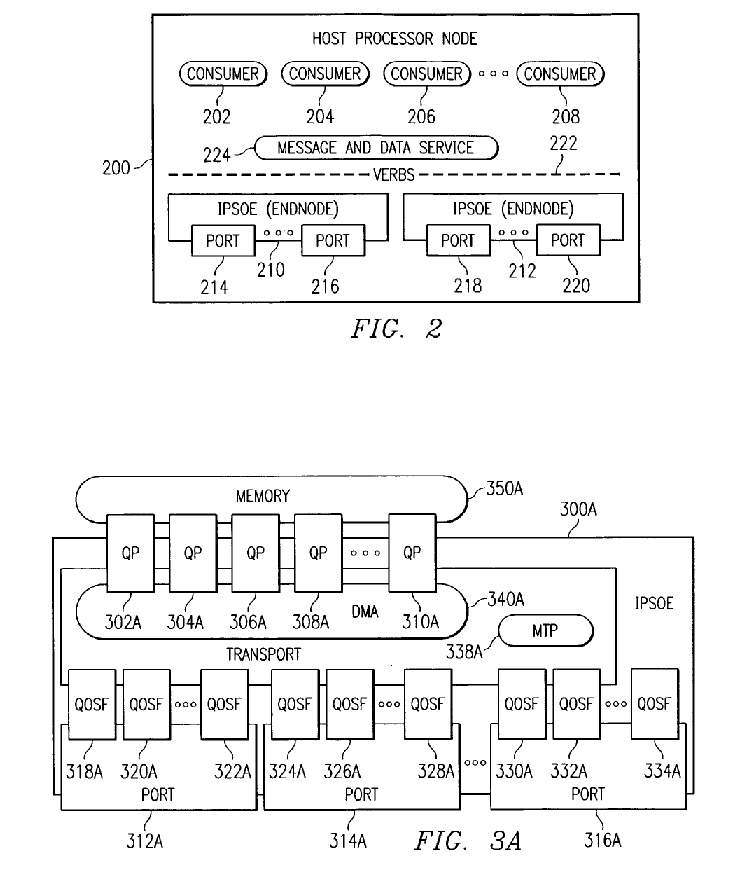

Turning next to FIG. 2, a functional block diagram of a host processor node is depicted in accordance with a preferred embodiment of the present invention. Host processor node 200 is an example of a host processor node, such as host processor node 102 in FIG. 1.

In this example, host processor node 200 shown in FIG. 2 includes a set of consumers 202-208, which are processes executing on host processor node 200. Host processor node 200 also includes IP Suite Offload Engine (IPSOE) 210 and IPSOE 212. IPSOE 210 contains ports 214 and 216 while IPSOE 212 contains ports 218 and 220. Each port connects to a link. The ports can connect to one subnet or multiple IP net subnets, such as IP net 100 in FIG. 1.

Consumers 202-208 transfer messages to the IP net via the verbs interface 222 and message and data service 224. A verbs interface is essentially an abstract description of the functionality of an IP Suite Offload Engine. An operating system may expose some or all of the verb functionality through its programming interface. Basically, this interface defines the behavior of the host. Additionally, host processor node 200 includes a message and data service 224, which is a higher-level interface than the verb layer and is used to process messages and data received through IPSOE 210 and IPSOE 212. Message and data service 224 provides an interface to consumers 202-208 to process messages and other data.

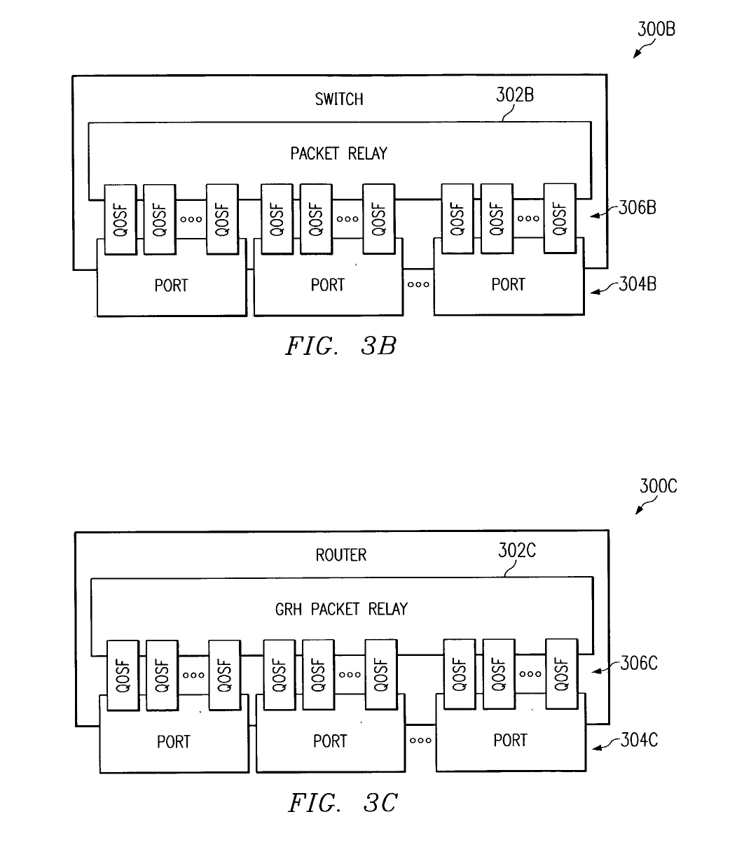

With reference now to FIG. 3A, a diagram of an IP Suite Offload Engine is depicted in accordance with a preferred embodiment of the present invention. IP Suite Offload Engine 300A shown in FIG. 3A includes a set of queue pairs (QPs) 302A-310A, which are used to transfer messages to the IPSOE ports 312A-316A. Buffering of data to IPSOE ports 312A-316A is channeled using the network layer's quality of service field, for example the Traffic Class field in the IP Version 6 specification, 318A-334A. Each network layer quality of service field has its own flow control. IETF standard network protocols are used to configure the link and network addresses of all IP Suite Offload Engine ports connected to the network. Two such protocols are Address Resolution Protocol (ARP) and Dynamic Host Configuration Protocol. Memory translation and protection (MTP) 338A is a mechanism that translates virtual addresses to physical addresses and validates access rights. Direct memory access (DMA) 340A provides for direct memory access operations using memory 350A with respect to queue pairs 302A-310A.

A single IP Suite Offload Engine, such as the IPSOE 300A shown in FIG. 3A, can support thousands of queue pairs. Each queue pair consists of a send work queue (SWQ) and a receive work queue (RWQ). The send work queue is used to send channel and memory semantic messages. The receive work queue receives channel semantic messages. A consumer calls an operating-system specific programming interface, which is herein referred to as verbs, to place work requests (WRs) onto a work queue.

FIG. 3B depicts a switch 300B in accordance with a preferred embodiment of the present invention. Switch 300B includes a frame relay 302B in communication with a number of ports 304B through link or network layer quality of service fields such as IP version 4's Type of Service field 306B. Generally, a switch such as switch 300B can route frames from one port to any other port on the same switch.

Similarly, FIG. 3C depicts a router 300C according to a preferred embodiment of the present invention. Router 300C includes a frame relay 302C in communication with a number of ports 304C through network layer quality of service fields such as IP version 4's Type of Service field 306C. Like switch 300B, router 300C will generally be able to route frames from one port to any other port on the same router.

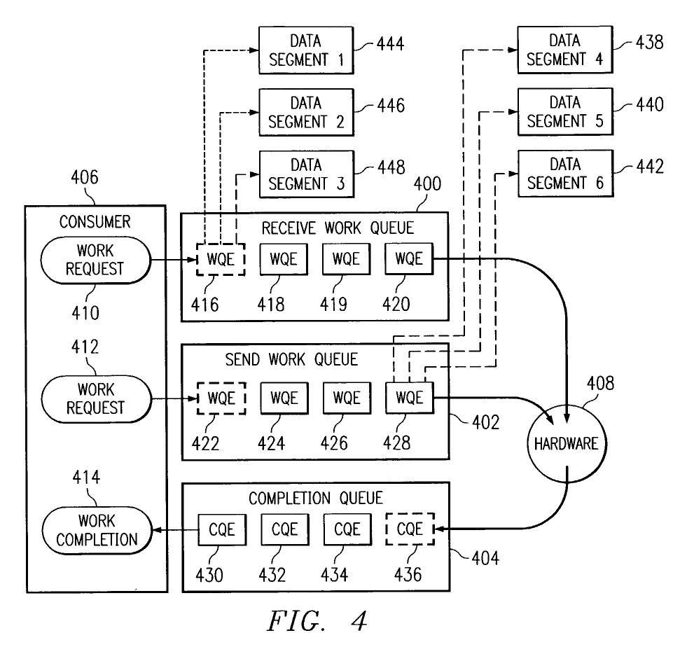

With reference now to FIG. 4, a diagram illustrating processing of work requests is depicted in accordance with a preferred embodiment of the present invention. In FIG. 4, a receive work queue 400, send work queue 402, and completion queue 404 are present for processing requests from and for consumer 406. These requests from consumer 406 are eventually sent to hardware 408. In this example, consumer 406 generates work requests 410 and 412 and receives work completion 414. As shown in FIG. 4, work requests placed onto a work queue are referred to as work queue elements (WQEs).

Send work queue 402 contains work queue elements (WQEs) 422-428, describing data to be transmitted on the IP net fabric. Receive work queue 400 contains work queue elements (WQEs) 416-420, describing where to place incoming channel semantic data from the IP net fabric. A work queue element is processed by hardware 408 in the IPSOE.

The verbs also provide a mechanism for retrieving completed work from completion queue 404. As shown in FIG. 4, completion queue 404 contains completion queue elements (CQEs) 430-436. Completion queue elements contain information about previously completed work queue elements. Completion queue 404 is used to create a single point of completion notification for multiple queue pairs. A completion queue element is a data structure on a completion queue. This element describes a completed work queue element. The completion queue element contains sufficient information to determine the queue pair and specific work queue element that completed. A completion queue context is a block of information that contains pointers to, length, and other information needed to manage the individual completion queues.

Example work requests supported for the send work queue 402 shown in FIG. 4 are as follows. A send work request is a channel semantic operation to push a set of local data segments to the data segments referenced by a remote node's receive work queue element. For example, work queue element 428 contains references to data segment 4 438, data segment 5 440, and data segment 6 442. Each of the send work request's data segments contains part of a virtually contiguous memory region. The virtual addresses used to reference the local data segments are in the address context of the process that created the local queue pair.

A remote direct memory access (RDMA) read work request provides a memory semantic operation to read a virtually contiguous memory space on a remote node. A memory space can either be a portion of a memory region or portion of a memory window. A memory region references a previously registered set of virtually contiguous memory addresses defined by a virtual address and length. A memory window references a set of virtually contiguous memory addresses that have been bound to a previously registered region.

The RDMA Read work request reads a virtually contiguous memory space on a remote endnode and writes the data to a virtually contiguous local memory space. Similar to the send work request, virtual addresses used by the RDMA Read work queue element to reference the local data segments are in the address context of the process that created the local queue pair. The remote virtual addresses are in the address context of the process owning the remote queue pair targeted by the RDMA Read work queue element.

A RDMA Write work queue element provides a memory semantic operation to write a virtually contiguous memory space on a remote node. For example, work queue element 416 in receive work queue 400 references data segment 1 444, data segment 2 446, and data segment 448. The RDMA Write work queue element contains a scatter list of local virtually contiguous memory spaces and the virtual address of the remote memory space into which the local memory spaces are written.

A RDMA FetchOp work queue element provides a memory semantic operation to perform an atomic operation on a remote word. The RDMA FetchOp work queue element is a combined RDMA Read, Modify, and RDMA Write operation. The RDMA FetchOp work queue element can support several read-modify-write operations, such as Compare and Swap if equal. The RDMA Fetchop is not included in current RDMA Over IP standardization efforts, but is described here, because it may be used as a value-add feature in some implementations.

A bind (unbind) remote access key (R_Key) work queue element provides a command to the IP Suite Offload Engine hardware to modify (destroy) a memory window by associating (disassociating) the memory window to a memory region. The R_Key is part of each RDMA access and is used to validate that the remote process has permitted access to the buffer.

In one embodiment, receive work queue 400 shown in FIG. 4 only supports one type of work queue element, which is referred to as a receive work queue element. The receive work queue element provides a channel semantic operation describing a local memory space into which incoming send messages are written. The receive work queue element includes a scatter list describing several virtually contiguous memory spaces. An incoming send message is written to these memory spaces. The virtual addresses are in the address context of the process that created the local queue pair.

For interprocessor communications, a user-mode software process transfers data through queue pairs directly from where the buffer resides in memory. In one embodiment, the transfer through the queue pairs bypasses the operating system and consumes few host instruction cycles. Queue pairs permit zero processor-copy data transfer with no operating system kernel involvement. The zero processor-copy data transfer provides for efficient support of high-bandwidth and low-latency communication.

When a queue pair is created, the queue pair is set to provide a selected type of transport service. In one embodiment, a distributed computer system implementing the present invention supports three types of transport services: TCP, SCTP, and UDP.

TCP and SCTP associate a local queue pair with one and only one remote queue pair. TCP and SCTP require a process to create a queue pair for each process that it is to communicate with over the IP net fabric. Thus, if each of N host processor nodes contain P processes, and all P processes on each node wish to communicate with all the processes on all the other nodes, each host processor node requires P²×(N−1) queue pairs. Moreover, a process can associate a queue pair to another queue pair on the same IPSOE.

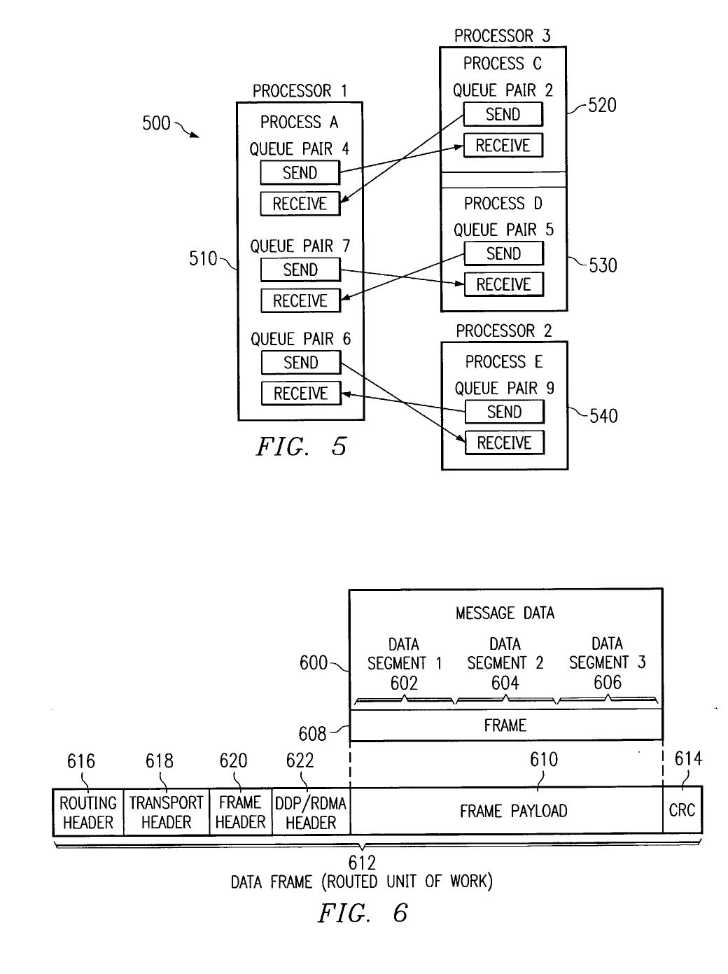

A portion of a distributed computer system employing TCP or SCTP to communicate between distributed processes is illustrated generally in FIG. 5. The distributed computer system 500 in FIG. 5 includes a host processor node 1, a host processor node 2, and a host processor node 3. Host processor node 1 includes a process A 510. Host processor node 2 includes a process C 520 and a process D 530. Host processor node 3 includes a process E 540.

Host processor node 1 includes queue pairs 4, 6 and 7, each having a send work queue and receive work queue. Host processor node 2 has a queue pair 9 and host processor node 3 has queue pairs 2 and 5. The TCP or SCTP of distributed computer system 500 associates a local queue pair with one and only one remote queue pair. Thus, the queue pair 4 is used to communicate with queue pair 2; queue pair 7 is used to communicate with queue pair 5; and queue pair 6 is used to communicate with queue pair 9.

A WQE placed on one send queue in a TCP or SCTP causes data to be written into the receive memory space referenced by a Receive WQE of the associated queue pair. RDMA operations operate on the address space of the associated queue pair.

In one embodiment of the present invention, the TCP or SCTP is made reliable because hardware maintains sequence numbers and acknowledges all frame transfers. A combination of hardware and IP net driver software retries any failed communications. The process client of the queue pair obtains reliable communications even in the presence of bit errors, receive underruns, and network congestion. If alternative paths exist in the IP net fabric, reliable communications can be maintained even in the presence of failures of fabric switches, links, or IP Suite Offload Engine ports.

In addition, acknowledgements may be employed to deliver data reliably across the IP net fabric. The acknowledgement may, or may not, be a process level acknowledgement, i.e. an acknowledgement that validates that a receiving process has consumed the data. Alternatively, the acknowledgement may be one that only indicates that the data has reached its destination.

The UDP is connectionless. The UDP is employed by management applications to discover and integrate new switches, routers, and endnodes into a given distributed computer system. The UDP does not provide the reliability guarantees of the TCP or SCTP. The UDP accordingly operates with less state information maintained at each endnode.

Turning next to FIG. 6, an illustration of a data frame is depicted in accordance with a preferred embodiment of the present invention. A data frame is a unit of information that is routed through the IP net fabric. The data frame is an endnode-to-endnode construct, and is thus created and consumed by endnodes. For frames destined to an IPSOE, the data frames are neither generated nor consumed by the switches and routers in the IP net fabric. Instead for data frames that are destined to an IPSOE, switches and routers simply move request frames or acknowledgment frames closer to the ultimate destination, modifying the link header fields in the process. Routers, may modify the frame's network header when the frame crosses a subnet boundary. In traversing a subnet, a single frame stays on a single service level.

Message data 600 contains data segment 1 602, data segment 2 604, and data segment 3 606, which are similar to the data segments illustrated in FIG. 4. In this example, these data segments form a frame 608, which is placed into frame payload 610 within data frame 612. Additionally, data frame 612 contains CRC 614, which is used for error checking. Additionally, routing header 616 and transport header 618 are present in data frame 612. Routing header 616 is used to identify source and destination ports for data frame 612. Transport header 618 in this example specifies the sequence number and the source and destination port number for data frame 612. The sequence number is initialized when communication is established and increments by 1 for each byte of frame header, DDP/RDMA header, data payload, and CRC. Frame header 620 in this example specifies the destination queue pair number associated with the frame and the length of the Direct Data Placement and/or Remote Direct Memory Access (DDP/RDMA) header plus data payload plus CRC. DDP/RDMA header 622 specifies the message identifier and the placement information for the data payload. The message identifier is constant for all frames that are part of a message. Example message identifiers include: Send, Write RDMA, and Read RDMA.

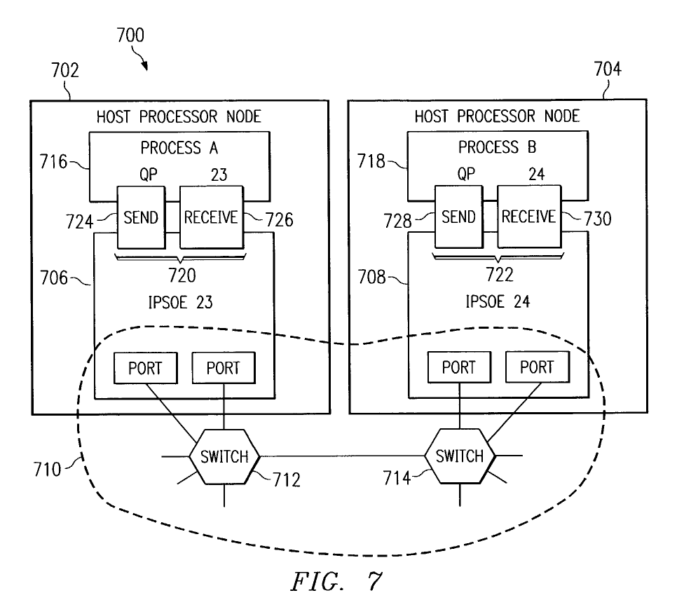

In FIG. 7, a portion of a distributed computer system is depicted to illustrate an example request and acknowledgment transaction. The distributed computer system in FIG. 7 includes a host processor node 702 and a host processor node 704. Host processor node 702 includes an IPSOE 706. Host processor node 704 includes an IPSOE 708. The distributed computer system in FIG. 7 includes a IP net fabric 710, which includes a switch 712 and a switch 714. The IP net fabric includes a link coupling IPSOE 706 to switch 712; a link coupling switch 712 to switch 714; and a link coupling IPSOE 708 to switch 714.

In the example transactions, host processor node 702 includes a client process A. Host processor node 704 includes a client process B. Client process A interacts with host IPSOE hardware 706 through queue pair 23. Client process B interacts with host IPSOE hardware 708 through queue pair 24. Queue pairs 23 and 24 are data structures that include a send work queue and a receive work queue.

Process A initiates a message request by posting work queue elements to the send queue of queue pair 23. Such a work queue element is illustrated in FIG. 4. The message request of client process A is referenced by a gather list contained in the send work queue element. Each data segment in the gather list points to part of a virtually contiguous local memory region, which contains a part of the message, such as indicated by data segments 1, 2, and 3, (444, 446, and 448) which respectively hold message parts 1, 2, and 3, in FIG. 4.

Hardware in host IPSOE 706 reads the work queue element and segments the message stored in virtual contiguous buffers into data frames, such as the data frame illustrated in FIG. 6. Data frames are routed through the IP net fabric, and for reliable transfer services, are acknowledged by the final destination endnode. If not successfully acknowledged, the data frame is retransmitted by the source endnode. Data frames are generated by source endnodes and consumed by destination endnodes.

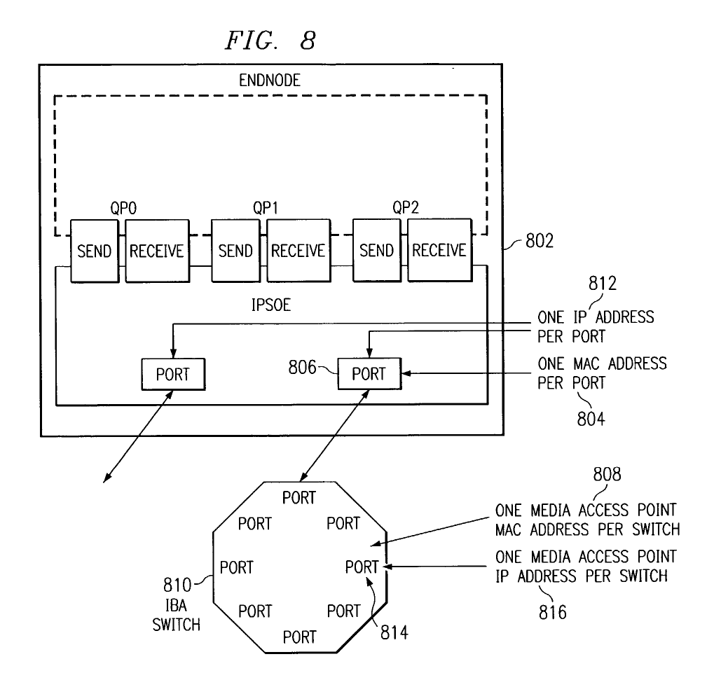

In reference to FIG. 8, a diagram illustrating the network addressing used in a distributed networking system is depicted in accordance with the present invention. A host name provides a logical identification for a host node, such as a host processor node or I/O adapter node. The host name identifies the endpoint for messages such that messages are destined for processes residing on an endnode specified by the host name. Thus, there is one host name per node, but a node can have multiple IPSOEs.

A single link layer address (e.g. Ethernet Media Access Layer Address) 804 is assigned to each port 806 of a endnode component 802. A component can be an IPSOE, switch, or router. All IPSOE and router components have a MAC address. A media access point on a switch is also assigned a MAC address.

One network address (e.g. IP Address) 812 is assigned to each each port 806 of a endnode component 802. A component can be an IPSOE, switch, or router. All IPSOE and router components must have a network address. A media access point on a switch is also assigned a MAC address.

Each port of switch 810 does not have link layer address associated with it. However, switch 810 can have a media access port 814 that has a link layer address 808 and a network layer address 816 associated with it.

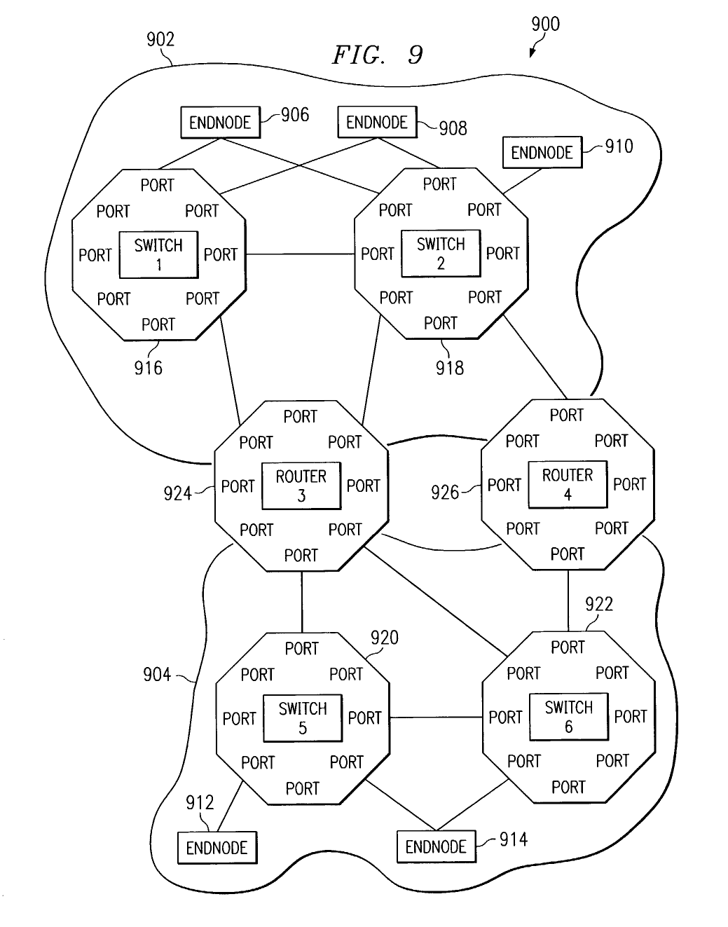

A portion of a distributed computer system in accordance with a preferred embodiment of the present invention is illustrated in FIG. 9. Distributed computer system 900 includes a subnet 902 and a subnet 904. Subnet 902 includes host processor nodes 906, 908, and 910. Subnet 904 includes host processor nodes 912 and 914. Subnet 902 includes switches 916 and 918. Subnet 904 includes switches 920 and 922.

Routers create and connect subnets. For example, subnet 902 is connected to subnet 904 with routers 924 and 926. In one example embodiment, a subnet has up to 216 endnodes, switches, and routers.

A subnet is defined as a group of endnodes and cascaded switches that is managed as a single unit. Typically, a subnet occupies a single geographic or functional area. For example, a single computer system in one room could be defined as a subnet. In one embodiment, the switches in a subnet can perform very fast wormhole or cut-through routing for messages.

A switch within a subnet examines the destination link layer address (e.g. MAC address) that is unique within the subnet to permit the switch to quickly and efficiently route incoming message frames. In one embodiment, the switch is a relatively simple circuit, and is typically implemented as a single integrated circuit. A subnet can have hundreds to thousands of endnodes formed by cascaded switches.

As illustrated in FIG. 9, for expansion to much larger systems, subnets are connected with routers, such as routers 924 and 926. The router interprets the destination network layer address (e.g. IP address) and routes the frame.

An example embodiment of a switch is illustrated generally in FIG. 3B. Each I/O path on a switch or router has a port. Generally, a switch can route frames from one port to any other port on the same switch.

Within a subnet, such as subnet 902 or subnet 904, a path from a source port to a destination port is determined by the link layer address (e.g. MAC address) of the destination host IPSOE port. Between subnets, a path is determined by the network layer address (IP address) of the destination IPSOE port and by the link layer address (e.g. MAC address) of the router port which will be used to reach the destination's subnet.

In one embodiment, the paths used by the request frame and the request frame's corresponding positive acknowledgment (ACK) frame is not required to be symmetric. In one embodiment employing oblivious routing, switches select an output port based on the link layer address (e.g. MAC address). In one embodiment, a switch uses one set of routing decision criteria for all its input ports. In one example embodiment, the routing decision criteria are contained in one routing table. In an alternative embodiment, a switch employs a separate set of criteria for each input port.

A data transaction in the distributed computer system of the present invention is typically composed of several hardware and software steps. A client process data transport service can be a user-mode or a kernel-mode process. The client process accesses IP Suite Offload Engine hardware through one or more queue pairs, such as the queue pairs illustrated in FIGS. 3A and 5. The client process calls an operating-system specific programming interface, which is herein referred to as “verbs.” The software code implementing verbs posts a work queue element to the given queue pair work queue.

There are many possible methods of posting a work queue element and there are many possible work queue element formats, which allow for various cost/performance design points, but which do not affect interoperability. A user process, however, must communicate to verbs in a well-defined manner, and the format and protocols of data transmitted across the IP net fabric must be sufficiently specified to allow devices to interoperate in a heterogeneous vendor environment.

In one embodiment, IPSOE hardware detects work queue element postings and accesses the work queue element. In this embodiment, the IPSOE hardware translates and validates the work queue element's virtual addresses and accesses the data.

An outgoing message is split into one or more data frames. In one embodiment, the IPSOE hardware adds a DDP/RDMA header, frame header and CRC, transport header and a network header to each frame. The transport header includes sequence numbers and other transport information. The network header includes routing information, such as the destination IP address and other network routing information. The link header contains the Destination link layer address (e.g. MAC address) or other local routing information.

If a TCP or SCTP is employed, when a request data frame reaches its destination endnode, acknowledgment data frames are used by the destination endnode to let the request data frame sender know the request data frame was validated and accepted at the destination. Acknowledgement data frames acknowledge one or more valid and accepted request data frames. The requester can have multiple outstanding request data frames before it receives any acknowledgments. In one embodiment, the number of multiple outstanding messages, i.e. Request data frames, is determined when a queue pair is created.

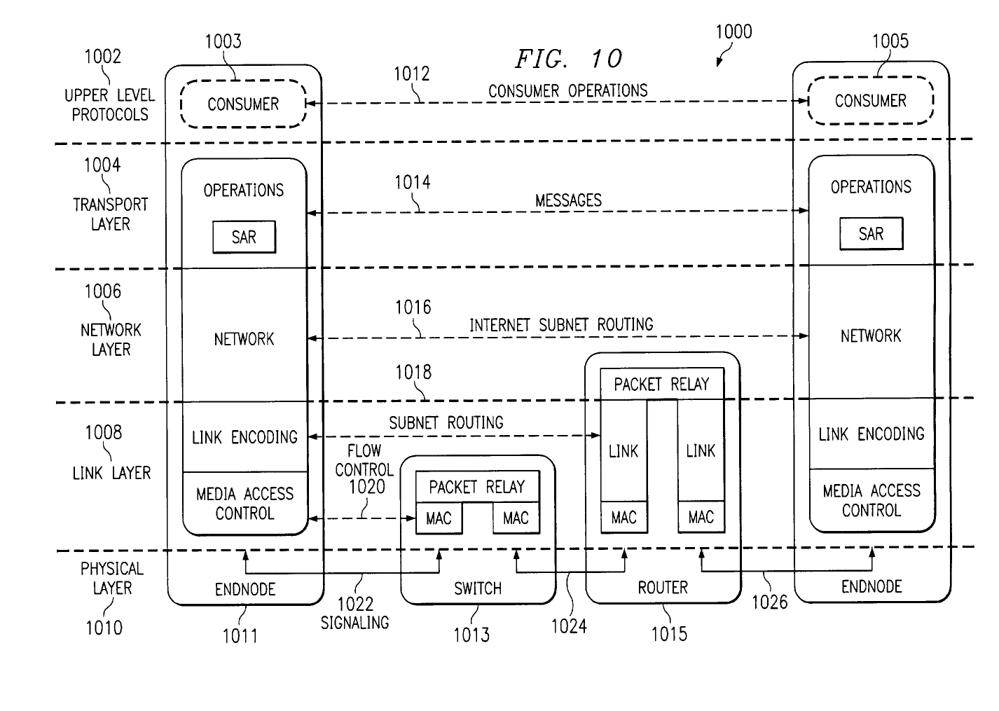

Referring to FIG. 10, a diagram illustrating one embodiment of a layered architecture is depicted in accordance with the present invention. The layered architecture diagram of FIG. 10 shows the various layers of data communication paths, and organization of data and control information passed between layers.

IPSOE endnode protocol layers (employed by endnode 1011, for instance) include an upper level protocol 1002 defined by consumer 1003, a transport layer 1004; a network layer 1006, a link layer 1008, and a physical layer 1010. Switch layers (employed by switch 1013, for instance) include link layer 1008 and physical layer 1010. Router layers (employed by router 1015, for instance) include network layer 1006, link layer 1008, and physical layer 1010.

Layered architecture 1000 generally follows an outline of a classical communication stack. With respect to the protocol layers of endnode 1011, for example, upper layer protocol 1002 employs verbs to create messages at transport layer 1004. Transport layer 1004 passes messages (1014) to network layer 1006. Network layer 1006 routes frames between network subnets (1016). Link layer 1008 routes frames within a network subnet (1018). Physical layer 1010 sends bits or groups of bits to the physical layers of other devices. Each of the layers is unaware of how the upper or lower layers perform their functionality.

Consumers 1003 and 1005 represent applications or processes that employ the other layers for communicating between endnodes. Transport layer 1004 provides end-to-end message movement. In one embodiment, the transport layer provides four types of transport services as described above which include traditional TCP, RDMA over TCP, SCTP, and UDP. Network layer 1006 performs frame routing through a subnet or multiple subnets to destination endnodes. Link layer 1008 performs flow-controlled, error checked, and prioritized frame delivery across links.

Physical layer 1010 performs technology-dependent bit transmission. Bits or groups of bits are passed between physical layers via links 1022, 1024, and 1026. Links can be implemented with printed circuit copper traces, copper cable, optical cable, or with other suitable links.

The iSCSI IPSOE supports iSCSI transactions. An iSCSI transaction consists of an iSCSI Command, optional Data Transfers, and an iSCSI Response. The proprietary storage interface calls from the operating system is translated to the IPSOE's iSCSI software-hardware interface through verbs. The verbs are implemented as a mixture of system memory resident data structures, adapter memory resident data structures, and adapter registers. Some iSCSI verbs can be accessed directly out of user space (e.g., send an iSCSI Command) through the iSCSI Library (a linkable library providing an application programming interface or API to iSCSI functions). Other iSCSI verbs can only be accessed from the kernel (e.g., Registering a Memory Region) through the iSCSI Driver.

For the iSCSI Host Adapter, the iSCSI Library creates an encapsulated iSCSI Command, which contains the iSCSI Command and a list of Data Transfer Data Segments associated with the iSCSI Command. The encapsulated iSCSI Command is transferred to the iSCSI IPSOE through the Send Queue. The iSCSI IPSOE creates an Initiator TAG for the iSCSI Command. The Initiator TAG serves two purposes. Firstly, it associates the iSCSI Command, optional associated Data Transfers, and iSCSI Response. Secondly, for iSCSI Commands requiring a data transfer (e.g. Write to Disk, Read from Disk), the Initiator TAG contains an index into the adapter's memory protection and translation table and a key value.

The iSCSI Host Adapter performs any data transfers associated with the iSCSI Command. The iSCSI Host Adapter places the Response for the iSCSI Command into the Receive Queue. The iSCSI Library retrieves the Response as a Receive Completion.

For the iSCSI Target Adapter, the adapter firmware interprets iSCSI Commands received through the Receive Queue. The iSCSI Target Adapter creates a Target TAG associated with the iSCSI Command. The Target TAG serves the same purposes as the Initiator TAG, except it is used to identify Target Adapter memory locations and state. The iSCSI Target Adapter posts Work Requests to the Send Queue to perform any data transfers associated with the iSCSI Command. When the iSCSI Command is complete, the iSCSI Target Adapter posts a Response message to the Receive Queue.

The iSCSI Adapter is associated with the iSCSI Driver through the iSCSI IPSOE Verb “Open”. This Verb returns a handle which uniquely references the iSCSI Adapter, i.e., if a single system has multiple iSCSI Adapters, each will have a unique handle. The iSCSI Library must use this handle each time it references the iSCSI Adapter. Once the iSCSI Adapter is associated with an iSCSI Driver, it cannot be opened again until after it has been closed.

Each iSCSI Adapter has a set of fixed and variable attributes, for example how many iSCSI Queue Pairs are supported by the adapter. The iSCSI Driver can determine these attributes through the iSCSI IPSOE Verb “Query”.

The iSCSI Adapter's variable attributes can be modified through the iSCSI IPSOE Verb “Modify”. This Verb is also used to initialize iSCSI Adapter Control Structures, such as the Memory Protection Table.

The iSCSI Driver disassociates itself from the iSCSI Adapter through the iSCSI IPSOE Verb “Close”.

A Protection Domain (PD) is used to associate iSCSI Queue Pairs with iSCSI Memory Regions and TAGs, as a means for enabling and controlling iSCSI IPSOE access to Host System memory. Each Queue Pair (QP) in an iSCSI Host Adapter is associated with a single PD. Multiple Queue Pairs can be associated with the same PD.

Each Memory Region, TAG, or Queue Pair is associated with a single PD. Multiple Memory Regions, TAGs, or Queue Pairs can be associated with the same PD.

Operations on a Queue Pair that access a Memory Region is allowed only if the Queue Pair's PD matches the PD of the Memory Region. Similarly, operations on a Memory Region or TAG is allowed only if the Memory Region or TAG's PD matches the PD of the Queue Pair.

The iSCSI Driver generates iSCSI Protection Domains (iSPD). The iSPD can be the Process ID. The iSCSI Driver maintains a table of all iSPDs that have been allocated by the iSCSI Library.

The iSCSI Adapter maintains the PD in QPs, Memory Regions, and TAG Entries. As a result the iSCSI Adapter does not require any special control structures for PDs.

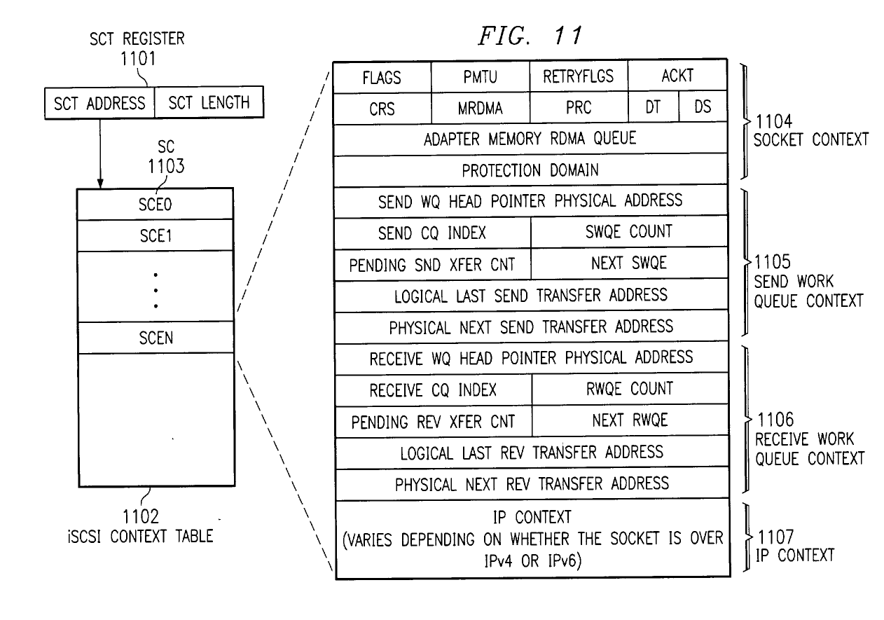

Each iSCSI IPSOE implementation supports a certain number of iSCSI Queue Pairs. The number of iSQPs is dependent on the amount of memory configured in the IPSOE Adapter. The number of iSQPs supported is given by the SCSI Context Table register (SCTR) 1101, shown in FIG. 11. This SCTR also contains the starting address of the iSQP Context Table (SCT) 1102. The SCT is located on the iSCSI Adapter.

The SCT contains a SCSI Context Table Entry 1103 for each iSQP. The SCTE contains the iSCSI context 1104, send queue context 1105, receive queue context 1106, and IP context 1107.

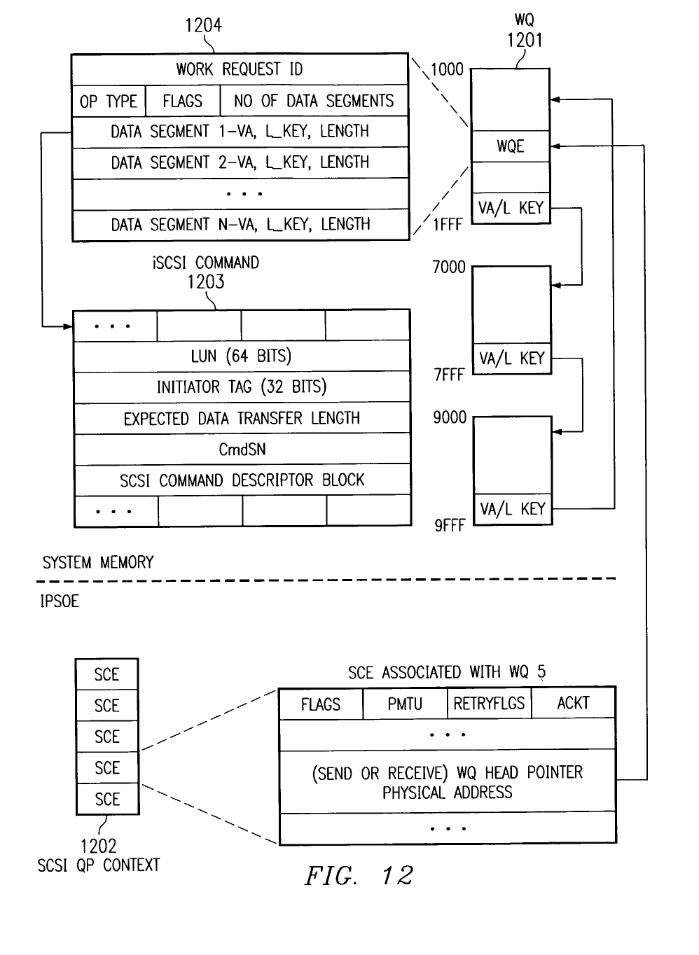

The iSCSI Library uses a Verb to submit a Work Queue Element (WQE) 1201 to a Send queue or a Receive queue, as shown in FIG. 12. Associated Send and Receive queues are collectively called an IPSOE SCSI Queue Pair (iSQP). An iSQP is not directly accessible by the SCSI consumer and can only be manipulated through the use of Verbs.

iSQP are created through the Verbs. When an iSQP is created, a complete set of initial attributes must be specified by the iSCSI Library.

The maximum number of WQEs 1201 that can be outstanding on each work queue of the iSQP is set by the SCSI Library when the iSQP is created.

The maximum number of outstanding WQEs includes the number of WQEs on that queue that have not completed plus the number of Completed Queue Entries (CQEs) for that queue that have not been freed through the associated Completion Queue (CQ).

The iSQP Context 1202 can be retrieved through the iSCSI IPSOE Interface verb “Query iSQP”.

The iSQP Context 1202 can be modified through the iSCSI IPSOE Interface verb “Modify iSQP”. The iSQP can be modified while WQEs are outstanding. Depending on the location of the IPSOE WQ and CQ pointers, the modification may not be immediate.

An iSQP is destroyed through the iSCSI IPSOE Interface verb “Destroy iSQP”. When an iSQP is destroyed, any outstanding WQEs are no longer considered to be in the scope of the IPSOE. It is the responsibility of the SCSI Library to be able to clean up any associated resources. Destruction of an iSQP releases any resources allocated within the IPSOE. Outstanding WQEs will not complete after this Verb returns.

The IPSOE SCSI Send Work Queue contains iSCSI encapsulated commands 1203. An encapsulated iSCSI command contains the iSCSI command, plus a scatter or gather list (SGL) 1204 for the data associated with the command. Each SGL element contains a virtual address, L_Key, and length. The virtual address is the address of the first byte of the SGL element. The length is the length, in bytes, of the SGL element. The L_Key is the handle of the memory region associated with the SGL element.

The IPSOE SCSI Receive Work Queue contains iSCSI encapsulated responses. An encapsulated iSCSI response contains the iSCSI response, plus a scatter list for any associated auxiliary response data. Each SGL element contains a virtual address, L_Key, and length.

A Completion Queue (CQ) 1301 shown in FIG. 13, can be used to multiplex work completions from multiple work queues across iSQP on the same IPSOE. The IPSOE supports Completion Queues (CQ) as the notification mechanism for WQE completions. A CQ can have zero or more work queue associations. Any CQ can be able to service send queues, receive queues, or both. Work queues from multiple iSQPs can be associated with a single CQ.

Completion Queues are created through the iSQP IPSOE verb “Create CQ”. The maximum number of Completion Queue Entries (CQEs) 1302 that can be outstanding on the completion queue is set by the iSCSI Library when the CQ is created. It is the responsibility of the iSCSI Library to ensure that the maximum number chosen is sufficient for the SCSI Consumer's operations; it must, in any case, arrange to handle an error resulting from CQ overflow.

Overflow of the CQ is detected and reported by the IPSOE before the next CQE is retrieved from that CQ. This error is reported as an affiliated asynchronous error.

The only Completion Queue attribute is the maximum number of entries in the CQ. This attribute can be retrieved through the iSQP IPSOE verb “Query CQ”. The iSCSI Library is responsible for keeping track of which WQs are associated with a CQ.

The CQ can be resized through the iSQP IPSOE verb “Modify CQ”. Resizing the CQ is allowed while WQEs are outstanding on WQs associated with the CQ. Resizing is performed through the iSQP IPSOE verb “Resize CQ”.

Completion Queues are destroyed through the iSQP IPSOE verb “Destroy CQ”. If the destruction of the CQ is invoked while Work Queues are still associated with the CQ, IPSOE returns an error and the CQ is not destroyed.

Destruction of a CQ releases any resources allocated at the IPSOE Interface on behalf of the CQ.

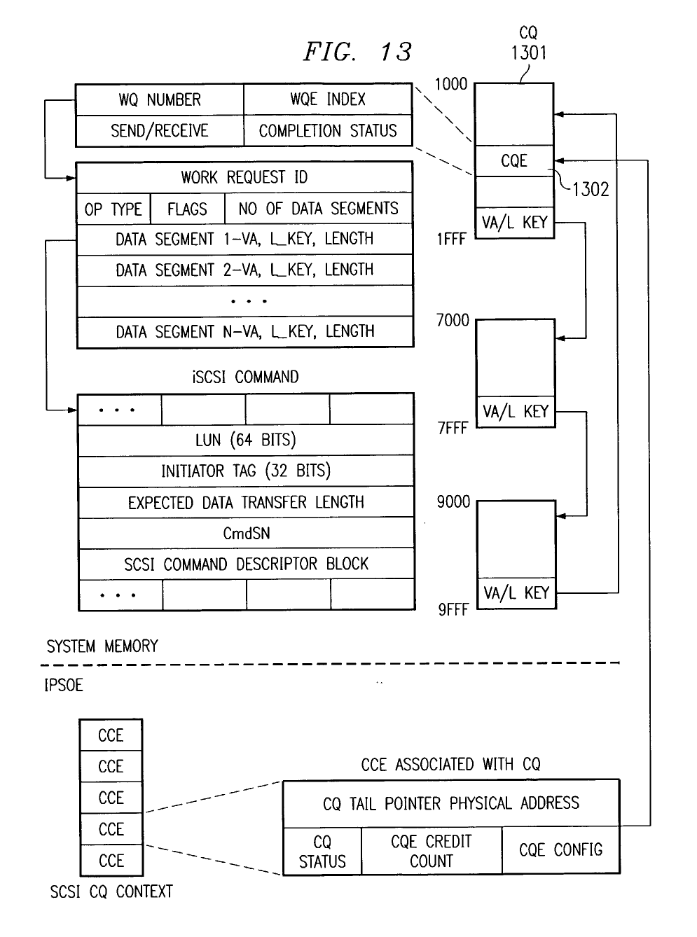

A state diagram showing the state transitions of an iSQP is shown in FIG. 14. This keeps the state definitions consistent and simplifies error semantics. The iSCSI IPSOE verb “Modify iSQP” transitions the iSQP between states. Additionally a completion error encountered by the IPSOE transitions the iSQP into the Error state 1405.

A newly created iSQP is placed in the Reset state 1401. It is possible to transition to the Reset state from any other state by specifying the Reset state when modifying the iSQP attributes. In the Reset state, the iSQP Context and WQ resources have been allocated. Upon creation, or transition to the Reset state, the iSQP and WQ attributes are set to the initialization defaults. Transition out of the Reset state can be effected by destroying the iSQP, thus exiting the state diagram. IPSOE ignores a WQE that has been submitted to a Work Queue while its corresponding iSQP is in the Reset State. The corresponding IPSOE WQ Context is updated. While in the Reset state the Work Queues are empty. No WQEs are outstanding on the work queues. All Work Queue processing is disabled. Incoming messages which target an iSQP in the Reset state are silently dropped.

In the Initialized (Init) state 1402, the basic iSQP attributes have been configured as defined by the verb “Modify iSQP”. Transition into this state is only possible from the Reset state 1401. The “Modify iSQP” verb is the only way for the SCSI Library to cause a transition out of the Init state, without destroying the iSQP. Transition out of the Init state can be effected by destroying the iSQP, thus exiting the state diagram. WQEs may be submitted to the Receive Queue but incoming messages are not processed. It is an error to submit WQEs to the Send Queue. If a WQE is submitted to a Send Queue, it is ignored and the Send Queue Context is not affected. Work Queue processing on both queues is disabled. Incoming messages which target an iSQP in the Init state are silently dropped.

In the Ready to Receive (RTR) state 1403, IPSOE supports the posting of WQEs to the Receive Queue. Incoming messages targeted at an iSQP in the RTR state are processed normally. Transition into this state is possible only from the Init state 1402, using the “Modify iSQP” verb. Transition out of the RTR state can be effected by destroying the iSQP, thus exiting the state diagram. Work Queue processing on the Send Queue is disabled. If a WQE is submitted to a Send Queue, it is ignored and the Send Queue Context is not affected.

Before transitioning to the Ready to Send (RTS) state 1404, the TCP/SDP communication establishment protocol must be completed. The connection between the requester's iSQP and responder's iSQP has been established. Transition into this state is possible only from the RTR state 1403. The “Modify iSQP” verb is the only way to cause a transition out of the RTS state, without destroying the iSQP. Transition out of the RTS state can be effected by destroying the iSQP, thus exiting the state diagram. IPSOE supports posting WQEs to an iSQP in the RTS state. WQEs on an iSQP in the RTS state are processed normally. Incoming messages targeted at an iSQP in the RTS state are processed normally.

In the Error state 1405, normal processing on the iSQP is stopped. A WQE which caused the Completion Error leading to the transition into the Error state returns the correct Completion Error Code for the error through the Completion Queue. This WQE may have been partially or fully executed, and thus may have affected the state of the receiver. Send operations may have been partially or fully completed; because of this, a completion queue entry may or may not have been generated on the receiver. RDMA Read operations may have been partially completed; because of this, the contents of the memory locations pointed to by the data segments of their WQE are indeterminate. RDMA Write operations may have been partially completed; because of this, the contents of the memory locations pointed to by the remote address of their WQEs are indeterminate. WQEs subsequent to that which caused the Completion Error leading to the transition into the Error state, including those submitted after the transition, return the Flush Error completion status through the Completion Queue. Some of the subsequent WQEs may have been in progress when the error occurred. This may have affected the state on the remote node. The possible effects depend on the WQE type as noted above. The “Modify iSQP” verb is the only way to cause a transition out of the Error state 1405 and into the iSQP Reset state 1401. Transition out of the Error state can also be effected by destroying the iSQP. For Affiliated Asynchronous Errors, it may not be possible to continue to process WQEs. In this case, outstanding WQEs are not completed. When handling the error notification, it is the responsibility of the iSCSI Library to ensure that all error processing has completed prior to forcing the iSQP to reset.

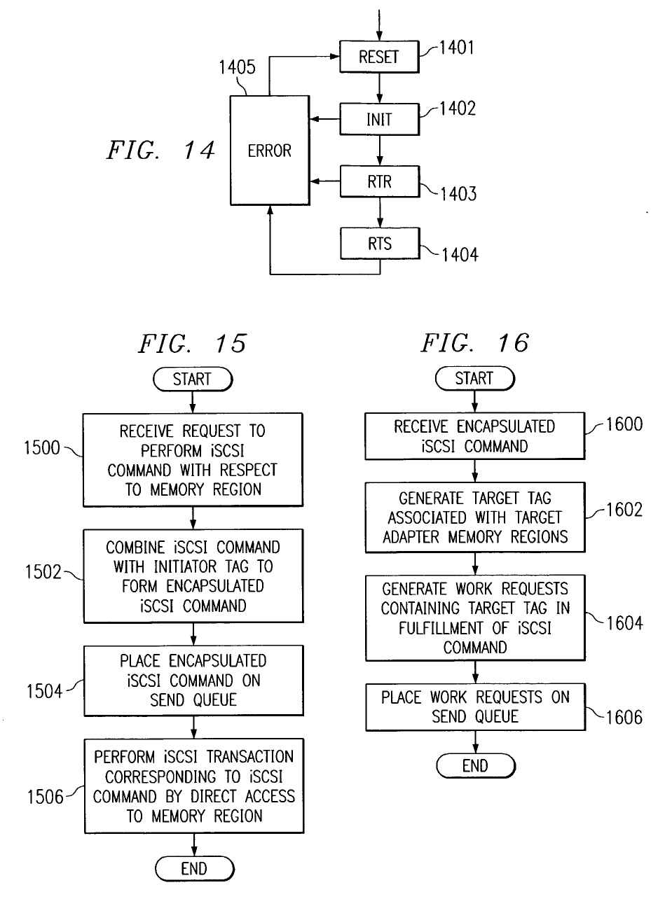

FIG. 15 is a flowchart representation of a process of a host initiating an iSCSI transaction with a target adapter in accordance with a preferred embodiment of the present invention. First, a request or function call is made to the iSCSI Library or operating system kernel to perform an iSCSI Command with respect to a particular memory region (step 1500). In response to the request or function call, the iSCSI library or OS kernel combines the iSCSI Command in the request with an Initiator TAG, resulting in an encapsulated iSCSI command (step 1502). The Initiator TAG acts as a memory handle to allow the target adapter to address the memory region. The encapsulated iSCSI command is placed on the send queue for transmission to the target adapter (step 1504). Once the target adapter has received the encapsulated iSCSI command, the transaction takes place by way of direct access to the memory region (step 1506). Essentially, this means that the host adapter either records data received from the target adapter directly to the memory region or reads data directly from the memory region for transmission to the target adapter. This direct-access scheme allows I/O transactions to take place without the additional overhead of copying the data to/from temporary buffers as an intermediate step. Rather, the teachings of the present invention allow for I/O reads and writes to be performed directly on the ultimate source or destination memory region.

FIG. 16 is a flowchart representation of a process of fulfilling an iSCSI command by a target adapter in accordance with a preferred embodiment of the present invention. The target adapter first receives an encapsulated iSCSI command from the host (step 1600). This encapsulated iSCSI command will contain a list of data segments in the target adapter to be affected by the iSCSI command. These data segments refer to memory regions within the target adapter. A target tag associated with these memory regions is generated (step 1602). Work requests to be processed in fulfillment of the iSCSI command are generated, with each work request containing the target tag (step 1604). The work requests are finally placed on the target adapter's send queue for processing in fulfillment of the iSCSI command (step 1606).

It is important to note that while the present invention has been described in the context of a fully functioning data processing system, those of ordinary skill in the art will appreciate that the processes of the present invention are capable of being distributed in the form of a computer readable medium of instructions or other functional descriptive material and in a variety of other forms and that the present invention is equally applicable regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system. Functional descriptive material is information that imparts functionality to a machine. Functional descriptive material includes, but is not limited to, computer programs, instructions, rules, facts, definitions of computable functions, objects, and data structures.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method comprising:
combining an iSCSI command with a tag to form an encapsulated iSCSI command, wherein the tag is associated with a memory region for holding data associated with the encapsulated iSCSI command;
performing an iSCSI transaction specified by the encapsulated iSCSI command by directly accessing the memory region.

2. The method of claim 1, wherein directly accessing the memory region includes writing the data associated with the encapsulated iSCSI command to the memory region.

3. The method of claim 1, wherein directly accessing the memory region includes reading the data associated with the encapsulated iSCSI command to the memory region.

4. The method of claim 1, wherein the iSCSI transaction includes transferring the data associated with the encapsulated iSCSI command to a target adapter.

5. The method of claim 1, wherein the iSCSI transaction includes transferring data associated with the encapsulated iSCSI command from a target adapter.

6. The method of claim 1, wherein the tag includes an index into a memory translation table.

7. The method of claim 1, further comprising:
placing the encapsulated iSCSI command on a send queue of a hardware network offload engine for processing.

8. The method of claim 1, further comprising:
determining if the iSCSI transaction has completed; and
in response to a determination that the iSCSI transaction has completed, placing a completion queue element on a completion queue.

9. A method operative in a target adapter, comprising:
receiving an encapsulated iSCSI command from a host adapter, wherein the encapsulated iSCSI command includes a iSCSI command, an initiator tag, and a list of data segments;
in response to receiving the encapsulated iSCSI command, generating a target tag associated with at least one memory region in the target adapter corresponding to the list of data segments; and
in response to receiving the encapsulated iSCSI command, transmitting work requests to the host adapter in fulfillment of the iSCSI command, wherein the work requests include the target tag.

10. The method of claim 9, wherein transmitting the work requests to the host adapter includes placing the work requests on a send queue for processing.

11. The method of claim 9, wherein receiving the encapsulated iSCSI command from the host adapter includes reading the encapsulated iSCSI command from a receive queue.

12. A computer program product in at least one computer-readable medium comprising functional descriptive material that, when executed by a computer, enables the computer to perform acts including:
combining an iSCSI command with a tag to form an encapsulated iSCSI command, wherein the tag is associated with a memory region for holding data associated with the encapsulated iSCSI command;
performing an iSCSI transaction specified by the encapsulated iSCSI command by directly accessing the memory region.

13. The computer program product of claim 12, wherein directly accessing the memory region includes writing the data associated with the encapsulated iSCSI command to the memory region.

14. The computer program product of claim 12, wherein directly accessing the memory region includes reading the data associated with the encapsulated iSCSI command to the memory region.

15. The computer program product of claim 12, wherein the iSCSI transaction includes transferring the data associated with the encapsulated iSCSI command to a target adapter.

16. The computer program product of claim 12, wherein the iSCSI transaction includes transferring data associated with the encapsulated iSCSI command from a target adapter.

17. The computer program product of claim 12, wherein the tag includes an index into a memory translation table.

18. The computer program product of claim 12, comprising additional functional descriptive material that, when executed by the computer, enables the computer to perform additional acts including:
placing the encapsulated iSCSI command on a send queue of a hardware network offload engine for processing.

19. The computer program product of claim 12, comprising additional functional descriptive material that, when executed by the computer, enables the computer to perform additional acts including:
determining if the iSCSI transaction has completed; and
in response to a determination that the iSCSI transaction has completed, placing a completion queue element on a completion queue.

20. A computer program product in at least one computer-readable medium comprising functional descriptive material that, when executed by a target adapter, enables the target adapter to perform acts including:
receiving an encapsulated iSCSI command from a host adapter, wherein the encapsulated iSCSI command includes a iSCSI command, an initiator tag, and a list of data segments;
in response to receiving the encapsulated iSCSI command, generating a target tag associated with at least one memory region in the target adapter corresponding to the list of data segments; and
in response to receiving the encapsulated iSCSI command, transmitting work requests to the host adapter in fulfillment of the iSCSI command, wherein the work requests include the target tag.

21. The computer program product of claim 20, wherein transmitting the work requests to the host adapter includes placing the work requests on a send queue for processing.

22. The computer program product of claim 20, wherein receiving the encapsulated iSCSI command from the host adapter includes reading the encapsulated iSCSI command from a receive queue.

23. A data processing system comprising:
a host computer including at least one processor and memory; and
a network offload engine associated with the host computer, adapted to send and receive information over a network to an iSCSI input/output adapter, and including a send queue,
wherein the at least one processor combines an iSCSI command with a tag to form an encapsulated iSCSI command, the tag being associated with a memory region in the memory for holding data associated with the encapsulated iSCSI command,
wherein the host computer places the encapsulated iSCSI command on the send queue, and
wherein the network offload engine performs an iSCSI transaction specified by the encapsulated iSCSI command by directly accessing the memory region.

24. The data processing system of claim 23, wherein performing the iSCSI transaction includes transmitting the encapsulated iSCSI command over the network to the adapter.
